(19) United States
(12) Patent Application Publication
(10) Pub. No.: US 2005/0267881 A1
(43) Pub. Date: Dec. 1, 2005

(54) Methods and systems for data storage

(76) Inventors: Christopher Betts, Victoria (AU); Tony Rogers, Victoria (AU)

Correspondence Address: COOPER & DUNHAM, LLP, 1185 AVENUE OF THE AMERICAS, NEW YORK, NY, 10036, US

(21) Appl. No.: 11/134,863

(22) Filed: May 19, 2005

Related U.S. Application Data
(60) Provisional application No. 60/573,147, filed on May 21, 2004.

(51) Int. Cl. G06F 17/30

(52) U.S. Cl. 707/4

(57) ABSTRACT

A method for storing data includes storing a user entry in a data repository, wherein the user entry comprises a unique identifier and a string of data, wherein the string of data comprises an XML data of the user entry as a single valued string.

### REFERENCE TO RELATED APPLICATION

The present disclosure is based on and claims the benefit of Provisional application Ser. No. 60/573,147 filed May 21, 2004, the entire contents of which are herein incorporated by reference.

### BACKGROUND

1. Technical Field

The present disclosure relates generally to system performance and, more particularly, to methods and systems for data storage.

2. Description of the Related Art

Web services provide a way for automated resources to be accessed by computer systems through the Internet. Computer system(s) as referred to herein may include(s) individual computers, servers, computing resources, networks, or combinations thereof, etc. Computer systems using standards-based web services can use Extensible Markup Language (“XML”) to communicate with each other. XML is language that uses a human readable format to tag data for web services.

The basic security requirements of web services can be the same as they are for traditional programs. For example, a user's identity can be authenticated before they are able to access web services. The Services Provisioning Markup Language (SPML) is the web services standard that defines how users can be stored, recovered, and how attributes are to be associated with those users.

One of the problems that web services often experience is slow performance. This results because the human readable XML data format is particularly verbose and can be computationally expensive to parse. Slow performance can be especially troublesome in user data repositories, which frequently have to cope with high access rates. For example, a large organization's administrative system might log on thousands of users around 9:00 am every day. If each request requires significant computational time, the load on the system would dramatically increase, slowing down system performance.

The SPML standard is an XML based framework for exchanging user, resource and service provisioning information between systems. SPML is used with directory technology for user storage and incorporates the Directory Service Markup Language (DSML) protocol for some elements of user access. However, the SPML architecture does not allow storage of entries in XML in a data repository, such as a relational database or directory. Thus, some form of translation is required for each SPML request that is to be stored in the various data repositories. For example, a SPML server might have to assemble the data in order to create SPML responses. This assembly step can be slow, as it requires a directory or database to be interrogated, possibly multiple times, and the data then collated and assembled into XML messages.

XML signatures are sensitive to the exact format of the XML data. Thus, in order to convert the XML data to a standard signature form, the XML data would have to undergo a canonicalization process. This process requires a system to perform additional parsing and processing work, which can slow system performance.

Accordingly, a need exists for techniques that overcome the disadvantages of conventional data storage techniques. It would be beneficial to have a method and system for optimum data storage of user data and timely and efficient processing of that data.

### SUMMARY

A method for storing data, according to an embodiment of the present disclosure, includes storing a user entry in a data repository, wherein the user entry comprises a unique identifier and a string of data, wherein the string of data comprises an XML data of the user entry as a single valued string.

A system for storing data, according to an embodiment of the present disclosure, includes means for storing a user entry in a data repository, wherein the user entry comprises a unique identifier and a string of data, wherein the string of data comprises an XML data of the user entry as a single valued string.

A computer storage medium including computer executable code for storing data, according to an embodiment of the present disclosure, includes code for storing a user entry in a data repository, wherein the user entry comprises a unique identifier and a string of data, wherein the string of data comprises an XML data of the user entry as a single valued string.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a block diagram of an exemplary computer system capable of implementing the method and system of the present application;

FIG. 2 shows a block diagram illustrating the format of a user entry, according to an embodiment of the present disclosure;

FIG. 3 shows a flow chart illustrating the execution of a add user request, according to an embodiment of the present disclosure;

FIG. 4 shows a flow chart illustrating the execution of a modify user request, according to an embodiment of the present disclosure;

FIG. 5 shows a flow chart illustrating the execution of a delete user request, according to an embodiment of the present disclosure; and

FIG. 6 shows a flow chart illustrating the execution of a search user request, according to an embodiment of the present disclosure.

### DETAILED DESCRIPTION

The present disclosure provides tools (in the form of methodologies, apparatuses, and systems) for storing data. The tools may be embodied in one or more computer programs stored on a computer readable medium or program storage device and/or transmitted via a computer network or other transmission medium.

The following exemplary embodiments are set forth to aid in an understanding of the subject matter of this disclosure, but are not intended, and should not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

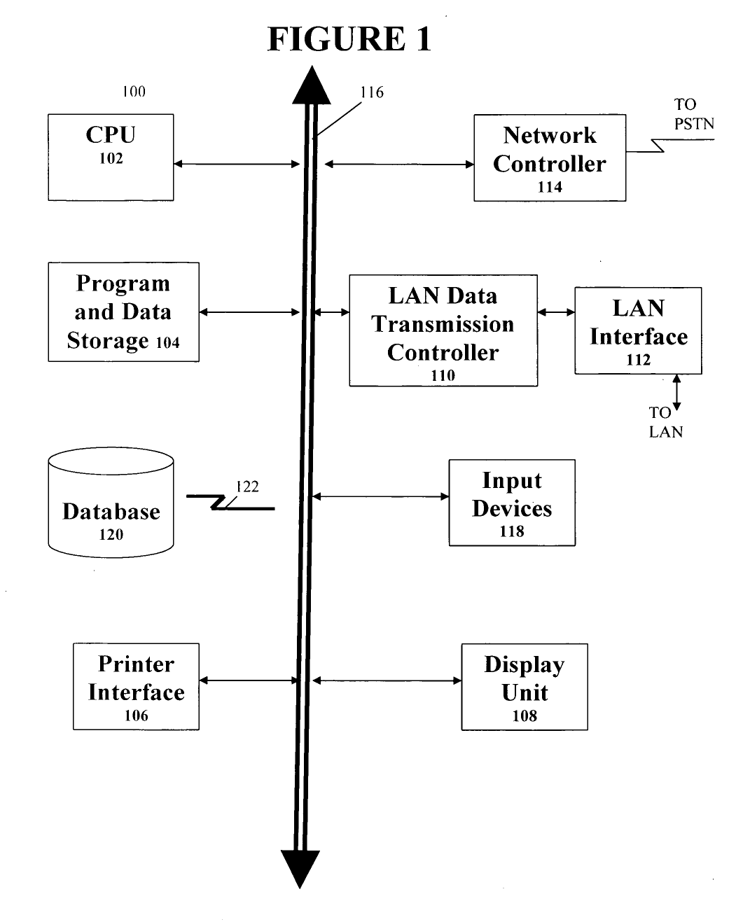

FIG. 1 shows an example of a computer system 100 which may implement the methods and systems of the present disclosure. The systems and methods of the present disclosure may be implemented in the fonrn of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

The specific embodiments described herein are illustrative, and many variations can be introduced on these embodiments without departing from the spirit of the disclosure or from the scope of the appended claims. Elements and/or features of different illustrative embodiments may be combined with each other and/or substituted for each other within the scope of this disclosure and appended claims.

According to an embodiment of the present disclosure, user data can be stored in an “SPML XML” format in a data repository in order to increase system performance. By storing the user data in XML format in a data repository, such as a directory, significant speed increases can be achieved for SPML requests and responses. For example, if the request is to “read a user”, the response would return a single text string retrieved from the directory without the XML parsing that would typically be required for the response to successfully execute. Significant performance increases can be achieved in the case where multiple user records are being returned at the same time. In that case, data can be read in a single directory operation that returns all user data XML strings at one time, rather than collating into XML the details of many different users.

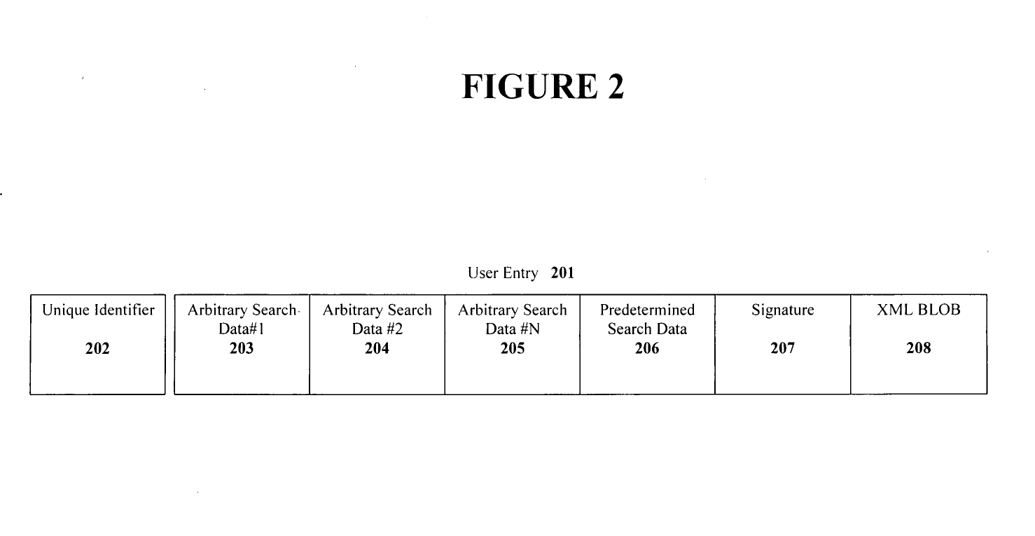

FIG. 2 is a block diagram illustrating the format of a user entry, according to an embodiment of the present disclosure. User data, such as SPML user data, can be stored as a user entry 201 containing an XML blob (contains the raw XML data) 208 as a single valued string attribute, a unique identifier 202, accompanying search data fields to facilitate fast searching 203-206, and a signature 207.

An arbitrary number of search data fields can be extracted from the user records when they are first written and stored as separate directory attributes. The search data fields can be used to index the data, allowing a system to promptly process data for fast retrieval. At least one arbitrary search field can be provided, for example, arbitrary search data#1 203, arbitrary search data#2 204, and arbitrary search data #N 205.

At least one predetermined search data 206 can also be provided containing generic searchable attributes of the form “name=value”. The predetermined search data 206 can be used, for example, if the searchable user attributes are not all known in advance, or if generic data needs to be searched.

A signature 207 can also be stored in a user entry 201. By storing a raw XML version of a signature 207 in a user entry 201, a system can simply return the signed data with an intact signature when requested, without requiring additional processing work.

Requests can be of four basic types: “add a user”, “modify a user”, “delete a user”, and “search for a user(s)” based on a search filter. Each request will be described in further detail below.

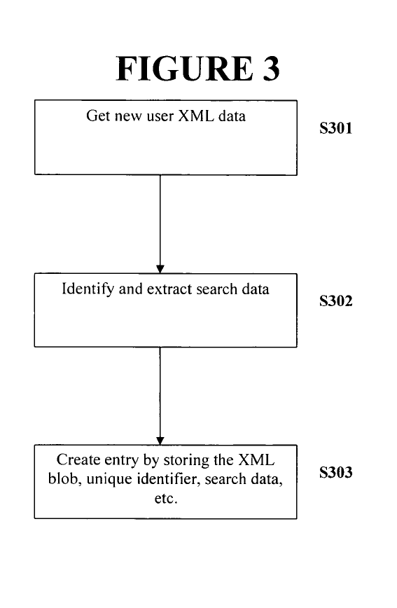

FIG. 3 is a flow chart illustrating the execution of a add user request, according to an embodiment of the present disclosure. The XML data is first extracted from a query, such as an SPML query (Step S301). The extracted XML data is then parsed in order to identify and extract the search data (Step S302). Finally, a user entry is created in a data repository, such as a directory or database, containing the following data: an XML blob, the unique identifier, and the search data containing the attributes required for searching (Step S303).

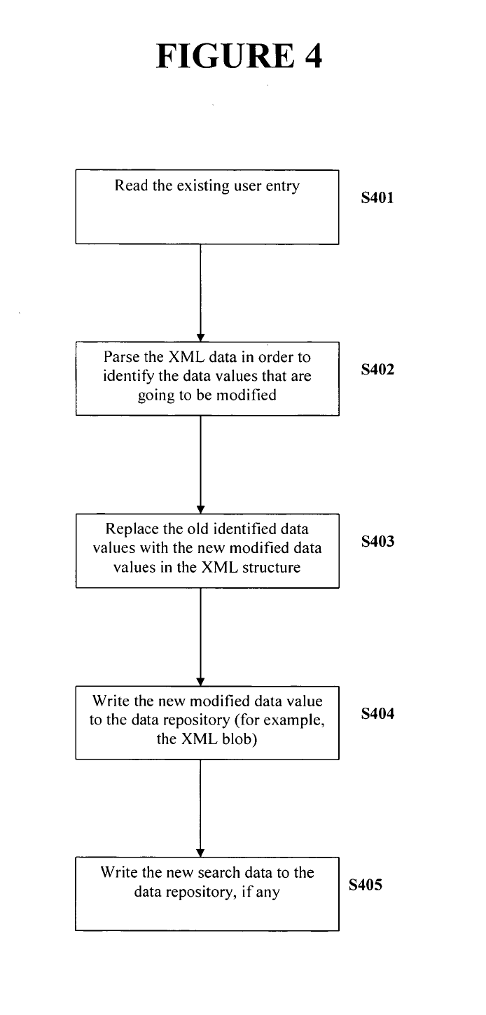

FIG. 4 is a flow chart illustrating the execution of a modify user request, according to an embodiment of the present disclosure. The original entry can be read (Step S401) and the XML data parsed in order to identify the data values that are going to be modified (Step S402). The attribute modifications can then be made to the XML structure by replacing the old identified data values with the new modified data values in the structure (Step S403). The modified XML can then be written back to the data repository, such as the directory, (Step S404) along with the changed search attributes, if any (Step S405). If the complete replacement of an existing user entry is executed, the entire existing user entry will be deleted in accordance with the “delete user” operation and the new entry will be added in accordance with the “add user” operation.

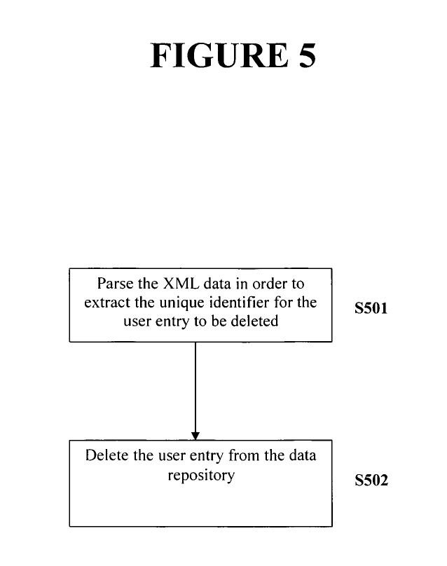

FIG. 5 is a flow chart illustrating the execution of a delete user request, according to an embodiment of the present disclosure. The XML data can be parsed to extract the unique identifier used to identify the user entry in the data repository (Step S501). No further parsing may be required, once the data has been parsed enough for the unique identifier to be extracted. The user entry can then be deleted from the data repository (Step S502).

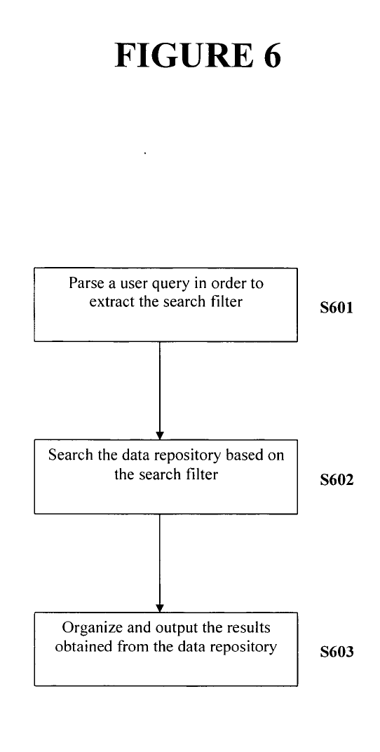

FIG. 6 is a flow chart illustrating the execution of a search user request, according to an embodiment of the present disclosure. A user query can be parsed to extract a search filter (Step S601) and then the data repository can be searched based on the search filter (Step S602). In many cases, the search filter can be used unaltered. However, the search filter can be modified for any attributes that use the predetermined search data. If the search filter is returning a user entry, or a set of user entries, then the data repository can be sent the search filter with a request to return the raw XML data of any matching entries. The processing that can be required for the SPML response is to concatenate all the XML entries and send them back to the original requesting user without parsing. If the search filter is only returning a subset of attributes, then an XML query can be manually constructed, and the attributes included in the XML query. The results obtained from the data repository can then be organized and output (Step S603).

Numerous additional modifications and variations of the present disclosure are possible in view of the above-teachings. It is therefore to be understood that within the scope of the appended claims, the present disclosure may be practiced other than as specifically described herein.

1. A method for storing data, comprising:
storing a user entry in a data repository, wherein the user entry comprises a unique identifier and a string of data, wherein the string of data comprises an XML data of the user entry as a single valued string.

2. The method of claim 1, wherein the data repository is a directory or database.

3. The method of claim 1, wherein the user entry is an SPML user entry.

4. The method of claim 1, wherein the user entry further comprises at least one arbitrary search term.

5. The method of claim 1, wherein the user entry further comprises at least one predetermined search term.

6. The method of claim 1, wherein the user entry further comprises a signature.

7. The method of claim 1, wherein the user entry is added to the data repository by extracting XML data from a query; identifying and extracting search data; and creating the user entry by storing the unique identifier, the XML data and the search data.

8. The method of claim 1, wherein the user entry is modified by reading the user entry; parsing through the XML data to identify which values are going to be modified; replacing the old identified values with new modified values; and storing the modified XML data in the data repository.

9. The method of claim 8, further comprising storing the modified search data in the data repository.

10. The method of claim 1, wherein the user entry is deleted by extracting the unique identifier for the user entry; and deleting the user entry from the data repository based on the unique identifier.

11. The method of claim 1, wherein the user entry is searched by parsing a user query in order to extract a search filter; searching the data repository based on the search filter; and organizing and outputting the results obtained from the data repository.

12. The method of claim 11, wherein the search filter is unaltered or modified for any attributes that use a predetermined search term.

13. The method of claim 11, wherein the XML data for one or more user entries requested is concatenated and sent back to the requesting user.

14. A system for storing data, comprising:
a system for storing a user entry in a data repository, wherein the user entry comprises a unique identifier and a string of data, wherein the string of data comprises an XML data of the user entry as a single valued string.

15. The system of claim 14, wherein the data repository is a directory or database.

16. The system of claim 14, wherein the user entry is an SPML user entry.

17. The system of claim 14, wherein the user entry further comprises at least one arbitrary search term.

18. The system of claim 14, wherein the user entry further comprises at least one predetermined search term.

19. The system of claim 14, wherein the user entry further comprises a signature.

20. The system of claim 14, wherein the user entry is added to the data repository by extracting XML data from a query; identifying and extracting search data; and creating the user entry by storing the unique identifier, the XML data and the search data.

21. The method of claim 14, wherein the user entry is modified by reading the user entry; parsing through the XML data to identify which values are going to be modified; replacing the old identified values with new modified values; and storing the modified XML data in the data repository.

22. The system of claim 21, further comprising a system for storing the modified search data in the data repository.

23. The system of claim 14, wherein the user entry is deleted by extracting the unique identifier for the user entry; and deleting the user entry from the data repository based on the unique identifier.

24. The system of claim 14, wherein the user entry is searched by parsing a user query in order to extract a search filter; searching the data repository based on the search filter; and organizing and outputting the results obtained from the data repository.

25. The system of claim 24, wherein the search filter is unaltered or modified for any attributes that use a predetermined search term.

26. The system of claim 24, wherein the XML data for one or more user entries requested is concatenated and sent back to the requesting user.

27. A computer storage medium including computer executable code for storing data, comprising:
code for storing a user entry in a data repository, wherein the user entry comprises a unique identifier and a string of data, wherein the string of data comprises an XML data of the user entry as a single valued string.

28. The computer storage medium of claim 27, wherein the data repository is a directory or database.

29. The computer storage medium of claim 27, wherein the user entry is an SPML user entry.

30. The computer storage medium of claim 27, wherein the user entry further comprises at least one arbitrary search term.

31. The computer storage medium of claim 27, wherein the user entry further comprises at least one predetermined search term.

32. The computer storage medium of claim 27, wherein the user entry further comprises a signature.

33. The computer storage medium of claim 27, wherein the user entry is added to the data repository by extracting XML data from a query; identifying and extracting search data; and creating the user entry by storing the unique identifier, the XML data and the search data.

34. The computer storage medium of claim 27, wherein the user entry is modified by reading the user entry; parsing through the XML data to identify which values are going to be modified; replacing the old identified values with new modified values; and storing the modified XML data in the data repository.

35. The computer storage medium of claim 34, further comprising code for storing the modified search data in the data repository.

36. The computer storage medium of claim 27, wherein the user entry is deleted by extracting the unique identifier for the user entry; and deleting the user entry from the data repository based on the unique identifier.

37. The computer storage medium of claim 27, wherein the user entry is searched by parsing a user query in order to extract a search filter; searching the data repository based on the search filter; and organizing and outputting the results obtained from the data repository.

38. The computer storage medium of claim 37, wherein the search filter is unaltered or modified for any attributes that use a predetermined search term.

39. The computer storage medium of claim 37, wherein the XML data for one or more user entries requested is concatenated and sent back to the requesting user.
